(19) United States
(12) Patent Application Publication
(10) Pub. No.: US 2007/0281668 A1
(43) Pub. Date: Dec. 6, 2007

(54) Dialing assistant that includes an interface with a geographic display

(75) Inventor: Lynda J. Fleming, Plano, TX (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/443,890

(22) Filed: May 31, 2006

(51) Int. Cl. H04Q 7/38; H04Q 7/22; H04M 3/42

(52) U.S. Cl. 455/414.1

(57) ABSTRACT

Apparatus for assisting a caller with the placement of a call from a telephone device to a called party in a foreign country. The apparatus being operable to display a geographic map; prompt the caller to select the foreign country from the geographic map; generate, responsive to selection of the foreign country by the caller, a digit string that includes a first access code, if any, for routing the call off of a private network. The digit string also including a second access code to route the call off of a national network associated with the location of the telephone device, and a country code of the foreign country. The caller is prompted to enter a local number of the called party. Digits of the local number are then appended to the digit string. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to the field of telecommunication systems; more specifically, to methods and apparatus for assisting with the dialing of telephone numbers.

### BACKGROUND OF THE INVENTION

In an increasingly global economy, international telephone calls are becoming more commonplace. To place an international telephone call requires that the calling party enter a relatively long sequence of numbers. For example, a person who wants to call someone in a foreign country typically has to press an initial digit, such as “9”, to dial out of a private network; then enter an International Direct Dialing (IDD) prefix needed to dial a call from a particular country to another country (such as “011” if the call is placed in the United States); and then enter the country code of the country he is calling (e.g., “44” for the United Kingdom, “81” for Japan, etc.). Once these prefix digits have been entered, a calling party may then enter the sequence of digits that comprise the actual phone number of a particular individual or business located in the foreign country.

The problem with this conventional type of dialing sequence is that it is cumbersome and can often be confusing, especially when the user has to manually enter these digits on a keypad. As a result, dialing errors frequently occur, which is both frustrating and a waste of time for the calling party. Often times, the calling party ends up seeking help from others who are more familiar with entering the correct prefix numbers associated with a particular foreign country. Furthermore, based on business card information or a business-wide directory lookup for a certain individual, it is often unclear exactly what digits a person is supposed to dial to route the call off the private network, route the call off the national network, and/or route the call to the appropriate country.

To add to the confusion, phone companies frequently add and divide destination dialing codes to accommodate for the growth in the number of subscribers. For example, the IDD prefix in many countries has been changing regularly. Requiring a user to be aware of unfamiliar destination codes of foreign countries, particularly when the country codes results in lack of productivity that is detrimental to productive endeavors.

A number of different telephone dialing assistance systems and methods already exist. For example, U.S. Patent Application No. 20020076009 discloses a system and method for providing speech recognition software in a telephone or telephone network for identifying a location and a telephone number spoken by a user. U.S. Patent Application No. 20040203757 discloses a system and technique that involves retrieving information from a network, identifying an international access code related to the retrieved information, and placing an international call through the network using the international access code. Similarly, U.S. Patent Application No. 20060034446 discloses a method of displaying an international telephone number in which a telephone number having an IDD prefix is received or stored in the telephone or on a memory card in the telephone. The telephone number is then displayed by inserting at least one space between a country code portion contained in the telephone number and subsequent numbers of the telephone number. The country code portion of the telephone number is determined by accessing a look-up table.

One problem with some of the prior art approaches is that they typically require the user to interface with a network, which can be slow or subject to temporary failure. Another problem is that some of the prior art approaches require the user to have knowledge of the IDD prefix for each country from which the user is placing a call. This is especially problematic when a calling party is traveling internationally and needs to place calls from multiple countries.

What is needed, therefore, is a user-friendly and efficient system and method for assisting a person with the dialing of international telephone calls that overcomes the drawbacks inherent in the prior art.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is an internet protocol telephone device having a display in accordance with one embodiment of the present invention.

FIG. 2 is a user-interface display screen showing a map of the world in accordance with one embodiment of the present invention.

FIG. 3 is another user-interface display screen showing a map of Europe in accordance with one embodiment of the present invention.

FIG. 4 is another user-interface display screen of a cell phone in accordance with one embodiment of the present invention.

FIG. 5 is another user-interface display screen in accordance with one embodiment of the present invention.

FIG. 6 is a method of operation in accordance with one embodiment of the present invention.

### DETAILED DESCRIPTION

A system and method that assists a user with the placement of international telephone calls using a telephone device with graphical capabilities, is described. In the following description, specific details are set forth, such as device types, system configurations, protocols, methods, etc., in order to provide a thorough understanding of the present invention. However, persons having ordinary skill in the relevant arts will appreciate that these specific details may not be needed to practice the present invention.

According to one embodiment of the present invention, a graphical user interface (GUI) of a mobile or desktop telephone device having a display equipped with touch-screen technology provides the calling party with the ability to quickly and automatically retrieve the prefix digits needed to place an international call to a particular foreign destination or called party. The touch-screen technology may include a scrollable map with zoom functions, allowing a user to select a country to which the called is to be placed. The GUI may be generated by software (i.e., code) running the user's telephone device. In other cases, the GUI may comprise a collaborative web-based application that is accessed by browser software running on the user's telephone device. In other instances, the GUI may comprise a downloaded application, or other forms of computer-executable code that may be loaded or accessed by a user's telephone device.

It is appreciated that other embodiments may implement a telephony user interface (TUI) or voice user interface (VUI) to implement the dialing assistant features of the present invention.

There are usually four parts of a dialed number that need to be entered in order to place an international call from a private enterprise location. For example, if a user is calling from within a business or private enterprise located in the United States, there is typically an access code to route the call off the private network. This digit is usually a single digit, such as “9” or “8”, although it could comprise more than one digit.

The next part of the telephone number that is needed for an international call is an access code to route the call off the national network. In a specific embodiment, the telephone device may be configured to identify the caller's current location using either standard cellular telephone triangulation techniques or global positional system (GPS) tracking technology. In the case of a desktop telephone device having a fixed location the access code for routing off the national network is a constant digit string (e.g., “011” for international calls from the U.S.) that may simply be programmed into the device.

For mobile or cellular phones, when the user invokes the dialing assistant GUI/TUI/VUI described herein, the program operates to first identify the user's current geographic location and network configuration in order to populate a digit buffer with the appropriate access code digits needed to dial off of the private and national networks. This information may be based on a static configuration of the telephone device, which may involve performing a lookup to a memory where the necessary access code information is stored. In other cases, the telephone device may perform a lookup to a server.

Thus, in one embodiment the program running on the telephone device first identifies the caller's present location (i.e., country or region) from where the user is placing the call. Then, based on that location, the program inserts the appropriate access code string into a dialing buffer. Again, this information may be obtained either from static information maintained in a memory of the telephone device or from an accessible database.

Next, the user of the phone is presented with a geographic map that displays various regions or countries that the user may select (e.g., via a touch screen display) as a destination country for his call. In a particular embodiment, a map of the world is first displayed, allowing the user to select a continent or region of the person to whom the call is being placed. If the selected continent or region includes multiple countries, a second map showing the various countries within the selected continent or region is displayed after the user selects a particular continent or region from the first global map. Using the second, more localized map, the user may select the destination country or region for his call. In response, the telephone device retrieves the foreign country calling prefix or country code and appends it into the string stored in the dialing buffer. Note that the country code information may be retrieved from a memory location of the telephone device, or by accessing a public database (e.g., via the Web).

In accordance with one embodiment of the present invention, at this point in the process the telephone device displays the current contents of the dialing buffer to the user and prompts the user to enter the remaining digits of the called party's number (e.g., the area or city code, followed by the destination phone number, which is usually a seven digit number). In other words, all that the user is required to do is identify (via the GUI/TUI/VUI) the country or region of the called party, and then enter the final part (i.e., local number) of the called party. Thus, the present invention obviates the need for the caller to enter any prefix digits needed to route the call to the destination foreign country.

Consider, as an example, a user who wants to place a call to a person in London, England. In accordance with one embodiment of the present invention, the user may invoke a specialized international dialing assistant GUI, using the GUI to select the portion of the world where England is located (i.e., Europe). The map then zooms in or changes to display a map of Europe. At that point, the user may select the country England (United Kingdom). In response to the user's country selection, the user's telephone device automatically populates a digit buffer with the appropriate access code string (i.e., private network, national network, and country code) needed to place the international call. The user is only responsible for entering the actual destination number, not any of the prefix digits that comprise the access codes discussed above.

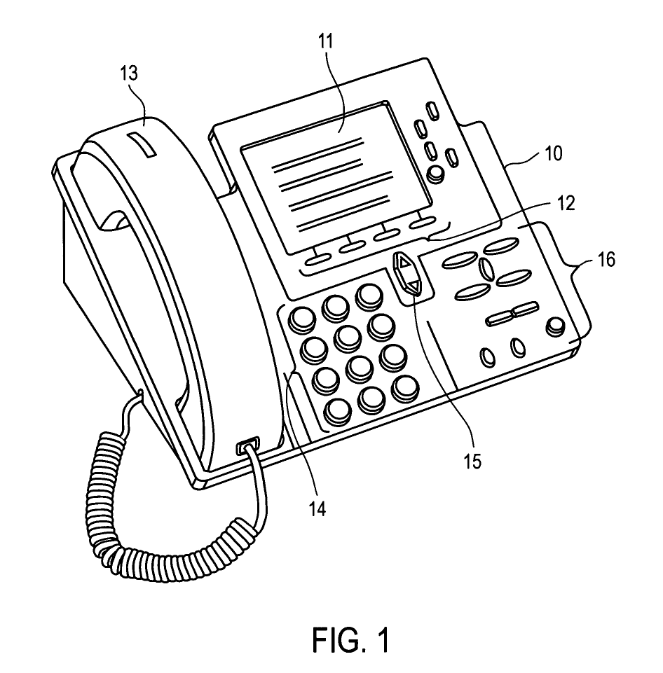

With reference now to FIG. 1, there is shown an Internet protocol (IP) telephone device 10 having a display screen 11 in accordance with one embodiment of the present invention. Telephone device 10 includes a base unit with a handset 13, a DTMF (alphanumerical) keypad 14, a volume control button 15, and a set of programmable function buttons 16 that may be programmed for functions such as speed dial, call forwarding, conference calls, voice messaging and the like are provided. For instance, one of buttons 16 may be programmed to automatically invoke the international dialing assistant user interface described herein. Intuitive “softkey” buttons 12 are also provided whereby a user may make various selections or take a particular action by pressing one of buttons 12 corresponding to a selection/action icon presented on display screen 11. Alternatively, touch screen technology may be used to interface with the map, thereby allowing the user to simply touch or “click” on the country or region of the map as part of the process of selecting a target network or destination country.

It should also be understood that a user may invoke the dialing assistant user interface in a number of different methods, such as via a menu selection, or by calling a phone number that downloads the GUI program to the telephone device. Also, instead of a GUI, the entire country or target network selection process may be entirely text-based; that is, instead of a geographic map the user would first be presented with a text listing of the various continents and regions of the world. After the user selects a continent or global region, the user interface transitions to a listing of the countries or local calling regions in the selected continent or global region. From there, the user may select the target network or destination country.

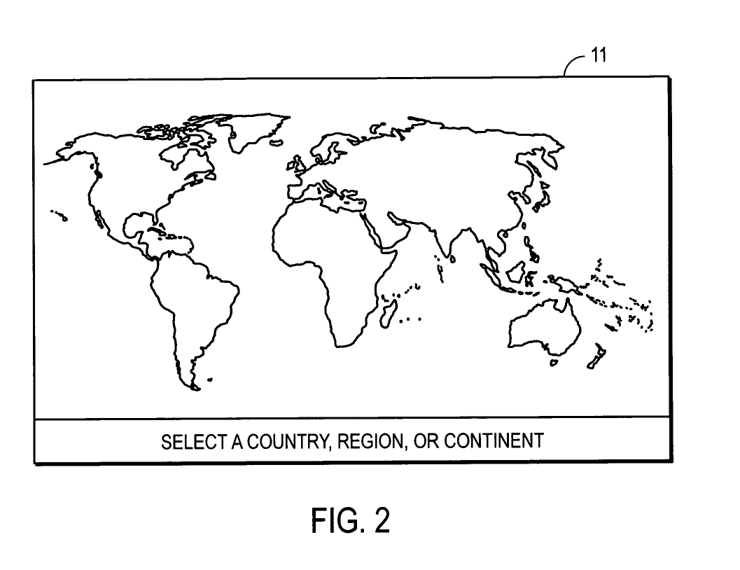

Regardless of how the user interface is invoked, in accordance with one embodiment of the present invention, once the user interface program is executed on the telephone device, a map of the world is presented to the user via the display screen 11. An example of such a map is shown in FIG. 2, which also includes a text prompt that asks the user to select a country, region, or continent displayed on the map. In the case where IP phone is equipped with touch screen capabilities, the user may make his selection simply by touching the area of screen 11 corresponding to the destination telephone number.

In cases where telephone device 10 is not equipped with touch screen technology, the GUI may operate to highlight various continents or regions responsive to pressing various function keys 16. For example, one or more function keys may be programmed to step through the different calling localities or countries—in the process highlighting each country or regional locality on the map. Another one of function keys 16 or softkey buttons 12 may be programmed to select the highlighted continent or region. Alternatively, a pointing input device, such as a pen input device, may be utilized to first select a particular continent on the global map, and then select a target network or country on the continent map.

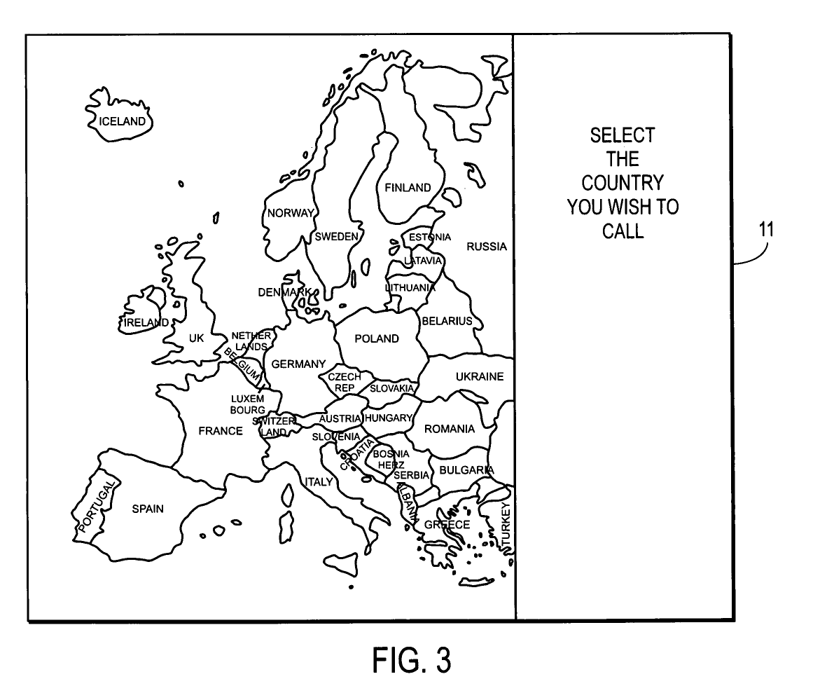

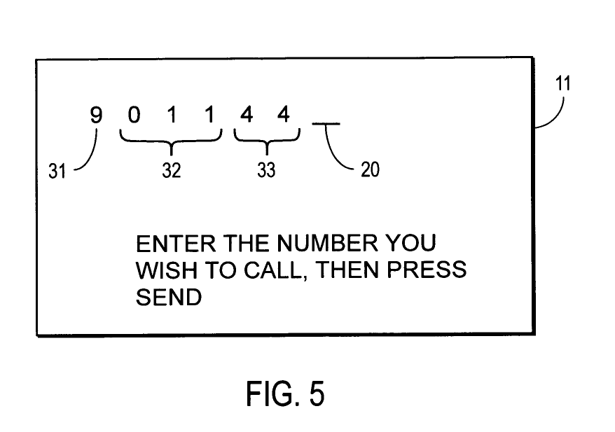

For example, if a calling party needs to place a call from a private enterprise located in Santa Clara, Calif., to a receiving (called) party in London, England, the calling party may simply use the input device to touch Europe on screen 11. By activating this portion of the map, the map then zooms in to center on a more detailed map of Europe (see FIG. 3). The user may then touch England (U.K.) on the European map. In response, the telephone device populates a digit buffer with the appropriate access code string needed to route the call off the private network, route off the national network, and target the international call to London, England. The user is then prompted to enter the digits comprising the last part of the telephone number of the person they want to call (see FIG. 5). This aspect of the present invention will be discussed in more detail below.

Note that in the case where the destination party is located in a very large nation, such as Russia, Canada, the United States, or Australia, the user may simply select (e.g., touch) that country in order to be prompted to enter the digits comprising the last part of the telephone number of the person they want to call. That is, for certain countries it is unnecessary to make a selection from a second, expanded map displayed on screen 11.

In addition to the embodiments described above, it should be understood that various other input forms, input devices, and human-computer interface systems may be used. Input forms, other than pointing and tactile inputs may include voice input of different commands via an interactive voice response (IVR) system. The control menus may also take various shapes/forms for compatibility with the input forms and devices utilized in the system.

FIG. 3 illustrates a user-interface display screen 11 showing a map of Europe in accordance with one embodiment of the present invention. This map may be displayed, for instance, as a result of a user selecting the European continent from the map shown in FIG. 2. A message at the side of the display screen 11 prompts the user to “Select the country you wish to call”. In this example, each country of Europe is clearly displayed. By using touch screen technology, a pointer input device, or some other selection mechanism (e.g., function keys 16 or softkey buttons 12), a user may select France on the screen 11 as the destination country of the called party. At this point, telephone device 11 automatically populates a dialing buffer with the required prefix access code digit string.

In cases where the target network or country is fairly small (e.g., Luxemburg) the user interface may display another expanded or zoomed in map of the region to allow the user to make an accurate selection from the touch screen of the display.

FIG. 5 shows user-interface display screen 11 in accordance with one embodiment of the present invention which includes various populated prefix digit fields 31-33, a cursor 20, and a message prompting the user to enter the final part of the telephone number of the party to whom the call is being placed. For instance, in the example of FIG. 5, the text message prompts the user to “Enter the number you wish to call, then press send.” As can be seen, the user interface program has already populated the digit buffer with the access code “9” in access code digit field 31, which represents the required digit needed to exit the private network. This is followed by the digits “011” in access code digit field 32, which represents the number needed to dial outside of the national network, which, in turn, is followed by the digits “44” in access code digit field 33, which represents the required digits for dialing to a particular country—in this case, the United Kingdom.

It is appreciated that the numbers visible in fields 31-33 on display screen 11 are also stored in a digit buffer that will be used to dial the called party once the user enters the final part of the number. This digit string has been populated with these particular access codes in response to selections made by the user on the previous map display screens (e.g., the world map and European maps of FIGS. 2 & 3, respectively) using a touch screen interface or some other selection device/mechanism. It should be understood that in cases where the calling party is not located on a private network, the first access code digit field 31 is eliminated or ignored. That is, the dialing buffer may begin with the access code digit field 32.

To complete the call the user simply enters the final part of the telephone number (e.g., the National Significant Number (NSN)) of the party the user wishes to call. As each digit is entered, it is displayed in the area immediately to the right of field 33, and cursor 20 moves over to the right to prompt the user to enter the next digit (e.g., by pressing the appropriate keypad button or by verbally saying the name of the digit). Once all of the digits of the final part of the telephone number have been entered, the caller may press “Send” or some other similar functional button on the telephone device to initiate transmission of the call across the various connecting networks to the called (destination) party.

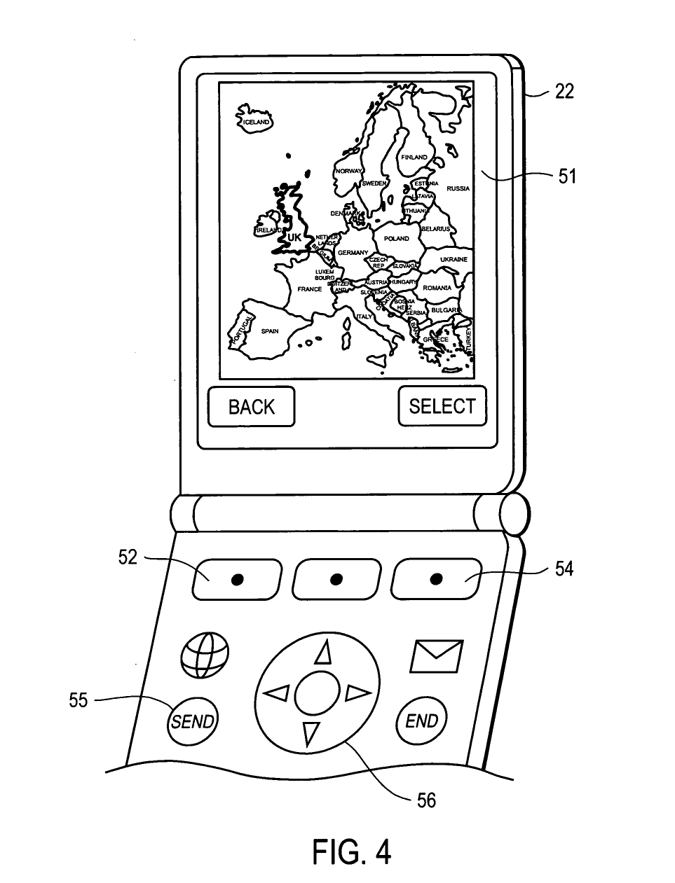

FIG. 4 illustrates a user-interface display screen in accordance with another embodiment of the present invention. FIG. 4 illustrates a mobile or cellular telephone (“cell phone”) 22 having a display panel or screen 51 that shows a user-interface display screen displaying a map of Europe. Cell phone 22 also has a keypad with a plurality of keys. Many of the elements on the cell phone are common on cell phone handsets in use today, such as buttons to launch an Internet Browser, to access a Message Center, and to “Send” and “End” phone calls. Arrow buttons 56 may be used to navigate through menu options which are displayed on the display screen, and, in this particular embodiment, to step through each of the different countries shown on the map—highlighting each country in the process.

In the example in FIG. 4, softkey button 52 corresponds to the “Back” icon shown on display screen 51. In this example, pressing button 52 causes the user interface to sequence back to a map of the world, such as that shown in FIG. 2. Similarly, softkey button 54 corresponds to the “Select” icon shown on display screen 51. For instance, by pressing button 54 a user may select the particular country highlighted on display screen 51. In the example shown, the United Kingdom (UK) is currently highlighted. Thus, a user who is located in the United States and who wishes to place a call to someone in London, for example, may simply press softkey button 54 to select the UK as the destination foreign country. The result of this selection is the display screen shown in FIG. 5, which includes a populated prefix consisting of fields 31-33 for dialing to the U.K. from the United States. All that is left is for the user to enter the NSN and press “Send” (i.e., button 55) in order to complete the call to the called party in London, England.

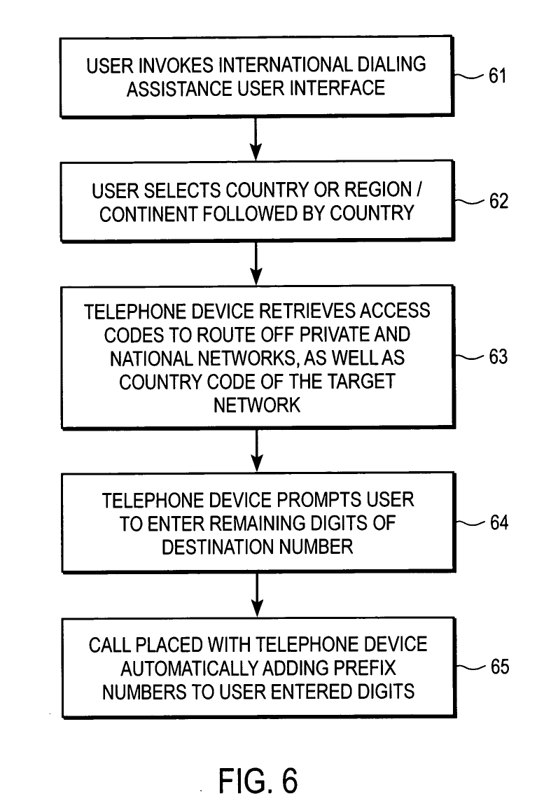

FIG. 6 is a method of operation in accordance with one embodiment of the present invention. The process starts with a user invoking an international dialing assistance user interface (block 61) through whatever telephone device the user happens to be using. The user interface may be embodied as executable code stored on the telephone device and executed by a processor; alternatively, the user interface may comprise code downloaded from a server or another network node. Once the user interface has been invoked, the user is presented with a screen that presents a geographic world map, from which the user may select a country or region/continent. After the user selects a continent or region, a second geographic map of the selected continent or region may be presented on the display screen. From this second screen, the user may select the particular country where the called party is located, i.e., the country where the user wishes to place a telephone call. This is shown occurring at block 62.

Once the user has made a foreign country selection, the telephone device (user interface) responds by retrieving the appropriate access codes needed to route the call off the private and national networks, as well as the country code of the target network (block 63). These prefix access code digits are stored as a digit string in a dialing buffer of the telephone device. Additionally, the prefix access code digits may be displayed to the user along with a prompt requesting the user to enter the final part (i.e., the NSN) of the destination telephone number (block 64). As the user enters the digits of the final part of the telephone number, each digit is appended to the prefix digits stored in the dialing buffer. In other words, after the user has completed entry of the NSN the dialing buffer contains all of the digits needed to make the call to the called party in the foreign country. Upon pressing the “send” button, the telephone call is placed with the telephone device automatically adding prefix numbers to the user-entered digits (block 65).

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

I claim:

1. Apparatus for assisting a caller with the placement of a call from a mobile telephone device to a called party in a foreign country comprising:
means for determining a geographic position of the mobile telephone device;
means, responsive to target network selection input of the caller, for automatically populating a dialing buffer with a first access code, if any, for routing the call off of a private network, a second access code to route the call off of a national network associated with the geographic position of the mobile telephone device, and the country code of the foreign country, the means for populating the dialing buffer further for prompting the caller to enter a final part of a telephone number of the called party.

2. The apparatus of claim 1 further comprising:
means for storing the first access code, the second access code, and a plurality of third access codes that includes the country code of the foreign country.

3. Apparatus for assisting a caller with the placement of a call from a telephone device to a called party in a foreign country, the telephone device being associated with a private network that is connected to a national network, comprising:
a user interface that provides the caller with the ability to select the foreign country of the called party; and
means, responsive to the selection of the caller, for automatically populating a dialing buffer with a first access code, if any, for routing the call off of a private network, a second access code to route the call off of a national network associated with the geographic position of the mobile telephone device, and the country code of the foreign country.

4. The apparatus of claim 3 wherein the means is further for prompting the caller to enter a National Significant Number (NSN) of a telephone number of the called party.

5. Logic for assisting a caller with the placement of a call from a telephone device to a called party in a foreign country, the logic being encoded in one or more media for execution and when executed operable to:
display a geographic map;
prompt the caller to select the foreign country from the geographic map;
generate, responsive to selection of the foreign country by the caller, a digit string that includes a first access code, if any, for routing the call off of a private network, a second access code to route the call off of a national network associated with the location of the telephone device, and a country code of the foreign country; and
prompt the caller to enter a local number of the called party, upon entry, digits of the local number being appended to the digit string.

6. The logic of claim 5, further operable to place the call using the digit string responsive to a command of the caller after the caller has entered the local number.

7. The logic of claim 5, wherein the digit string is stored in a buffer of the telephone device.

8. The logic of claim 5, wherein the telephone device includes a memory to store the first access code, a plurality of national network access codes that includes the second access code, and a plurality of country codes that includes the country code of the foreign country.

9. The logic of claim 5, wherein the selection of the foreign country is made via a touch screen input of the caller.

10. The logic of claim 5, wherein the local number comprises a National Significant Number (NSN).

11. The logic of claim 5, further operable to:
display a world map; and
prompt the caller to select a continent or region from the world map, wherein the geographic map displayed corresponds to the continent or region selected by the caller from the world map.

12. A processor-implemented method of assisting a caller with the placement of an international call from a telephone device to a called party in a foreign country, comprising:
displaying a world map to the caller;
prompting the caller to select a continent or region from the world map;
displaying a continent/regional map, the continent/regional map corresponding to the continent or region selected by the caller from the world map;
prompting the caller to select the foreign country from the continent/regional map;
generating, responsive to the foreign country selected by the caller, a digit string that includes a first access code, if any, for routing the call off of a private network, a second access code to route the call off of a national network associated with a current location of the telephone device, and a country code of the foreign country; and
prompting the caller to enter a local number of the called party, upon entry, digits of the local number being appended to the digit string.

13. The processor-implemented method of claim 12 further comprising:
placing the call using the digit string responsive to a command of the caller.

14. The processor-implemented method of claim 12 further comprising:
storing the digit string in a buffer.

15. The processor-implemented method of claim 12 further comprising:
accessing a memory that stores the first access code, a plurality of national network access codes that includes the second access code, and a plurality of country codes that includes the country code of the foreign country.

16. A processor-implemented method of assisting a caller with the placement of an international call from a telephone device to a called party in a foreign country, comprising:
prompting the caller to select the foreign country via a user interface;
generating, responsive to the foreign country selected by the caller, a digit string that includes a first access code, if any, for routing the call off of a private network, a second access code to route the call off of a national network associated with a current location of the telephone device, and a country code of the foreign country; and
prompting the caller to enter a local number of the called party via the user interface;
appending digits of the local number to the digit string.

17. The processor-implemented method of claim 16 wherein the user interface comprises a graphical user interface (GUI).

18. The processor-implemented method of claim 16 wherein the user interface comprises a telephony user interface (TUI).

19. The processor-implemented method of claim 16 wherein prompting the caller to select the foreign country comprises:
displaying a world map to the caller;
prompting the caller to select a continent, region, or the foreign country from the world map.

20. The processor-implemented method of claim 19 further comprising:
displaying a continent/regional map responsive to a continent or regional selection by the caller, the continent/regional map including the foreign country;
prompting the caller to select the foreign country from the continent/regional map.

21. The processor-implemented method of claim 16 further comprising:
placing the call using the digit string responsive to a command of the caller, the digit string including the digits of the local number.

22. The processor-implemented method of claim 16, wherein the local number comprises a National Significant Number (NSN).
